(19) United States
(12) Patent Application Publication
(10) Pub. No.: US 2014/0117108 A1
(43) Pub. Date: May 1, 2014

(54) Smart Irrigation Assistant

(71) Applicant: Vuong Binh Hong, Costa Mesa, CA (US)

(72) Inventor: Vuong Binh Hong, Costa Mesa, CA (US)

(21) Appl. No.: 13/662,469

(22) Filed: Oct. 27, 2012

(51) Int. Cl. A01G 25/16

(52) U.S. Cl. CPC A01G 25/167
USPC 239/64

(57) ABSTRACT

The Smart Irrigation Assistant (SIA) adaptor works in conjunction with an existing standard sprinkler timer to automatically modify the amount of water that is delivered to each zone based on the relative humidity. Provisions are also made for having the water delivered in intervals within the maximum time set on the standard sprinkler timer. This allows time for the water to soak into the ground before the remainder of the water allocated for that zone is applied. The SIA is powered from the existing standard sprinkler timer. It is connected to each of the wires that control the irrigating valves and it is connected in series with the common (ground) wire that goes to all valves. The SIA breaks the connection on the common circuit to the valves in order to stop the flow of water to the active zone.

### REFERENCE

U.S. Pat. No. 7,063,271 June 2006 Lashgari

U.S. Pat. No. 5,853,122 February 1998 Caprio

U.S. Pat. No. 5,847,568 Dec. 8, 1998 Stashkiw, et al.

U.S. Pat. No. 7,063,271, June 2006, Lashgari, “Moisture responsive sprinkler circuit” uses ground humidity in the sprinkler control system. This approach has the advantage of measuring the moisture at the ground next to the roots of the plants; however, this approach has the drawbacks due to variations between the different zones being watered. The humidity at one point of the ground can be very different from the next. This disadvantage is more profound if the ground is not level. The present invention use air relative humidity to solve that problem. There is a close relationship between the air relative humidity and the ground humidity. If we carefully utilize the Relative Humidity reading, we can indirectly control the moisture of the ground. Furthermore, the air Relative Humidity is a very important factor for the plants. The air temperature and humidity affects the rate of evaporation of water from the land and plants. Thus the air relative humidity can help us to determine how much water is needed to irrigate the land with optimum results. The smart sprinkler system controllers have high accuracy but they are expensive and can require extensive maintenance. The present invention solves that problem by introducing a very simple, low cost, easy to operate, automatic and maintenance free solution.

U.S. Pat. No. 5,853,122, Caprio, Dec. 29, 1998, “Relative humidity sensitive irrigation valve control” intends to use relative humidity to control the sprinklers. The disadvantage of this invention is that it uses a humidistat and a thermostat to configure the RH of the air. This is very inconvenient, requires a lot of space and is not very accurate. This invention uses a very small electronic sensor to measure the RH of the air and the control circuit is also very small. The SIA is much smaller, very cost effective, more accurate and much less maintenance.

U.S. Pat. No. 5,847,568, Stashkiw, et al. Dec. 8, 1998, “Moisture sensor and irrigation control system”. This invention tries to measure the land moisture by the photo sensor. This approach is not very accurate. This invention (the SIA) uses a Relative Humidity sensor chip which is more accurate.

### BACKGROUND OF THE INVENTION

There is a critical need to conserve water due to limited resources and an increasing population; however, it is important to ensure that the landscape receives the optimum amount of water required to keep it healthy.

The Smart Irrigation Assistant (SIA) is an add-on that works in conjunction with a standard sprinkler timer to create a smart irrigation control system. The SIA combined with a standard sprinkler timer will automatically control the amount of watering time based on the relative humidity and the characteristics of the zone being watered.

The amount of water needed for a given irrigation zone varies based on the types of plants being watered, on the type of soil, on the temperature and on the amount of moisture in the air. Temperature and moisture in the air determines the rate of evapotranspiration (ET) of water from the land and plants. The hotter and drier the air in an area, the more water will be needed to irrigate the plants. To determine how much water is optimum to irrigate a zone at a given time, the relative humidity (RH) value is an important factor. The standard sprinkler timer cannot adapt to variations in these parameters. This makes it very difficult to avoid over watering or under watering. Commercial Smart Irrigation Controllers are much better at adapting to these parameters, but they are expensive, complicated to use and can requires extensive maintenance. The present invention solves these issues by providing a simple, low budget way to enhance the standard sprinkler timer, allowing it to work as a Smart Irrigation Controller.

One simply adjusts the watering time of the standard sprinkler timer according to the formula in claim 7. The rest will be taken care of by the present invention.

### BRIEF SUMMARY OF THE INVENTION

The Smart Irrigation Assistant (SIA) is an add-on that works in conjunction with a standard sprinkler timer to create a smart irrigation control system. The SIA combined with a standard sprinkler timer will automatically control the amount of watering time based on the relative humidity and the characteristics of the zone being watered.

### BRIEF DESCRIPTION OF THE SEVERAL VIEWS OF THE DRAWING

The above and other aspects, features and advantages of the present invention will be made more apparent by the following detailed descriptions and drawings wherein:

FIG. 1 is a smart irrigation control system including a standard irrigation timer and the Smart Irrigation Assistant according to the present invention.

FIG. 2 shows the timing diagram of the watering time and soaking time according to the present invention.

### DETAILED DESCRIPTION OF THE INVENTION

The following description is of the best method presently contemplated for carrying out the invention. This description is not to be taken in a limiting sense, but is made merely for the purpose of describing one or more preferred embodiments of the invention. The scope of the invention should be determined with reference to the claims.

The present invention provides a simple but effective apparatus and method to enhance the standard sprinkler timer to become a low cost, automatic, maintenance free Smart Irrigation Controller system.

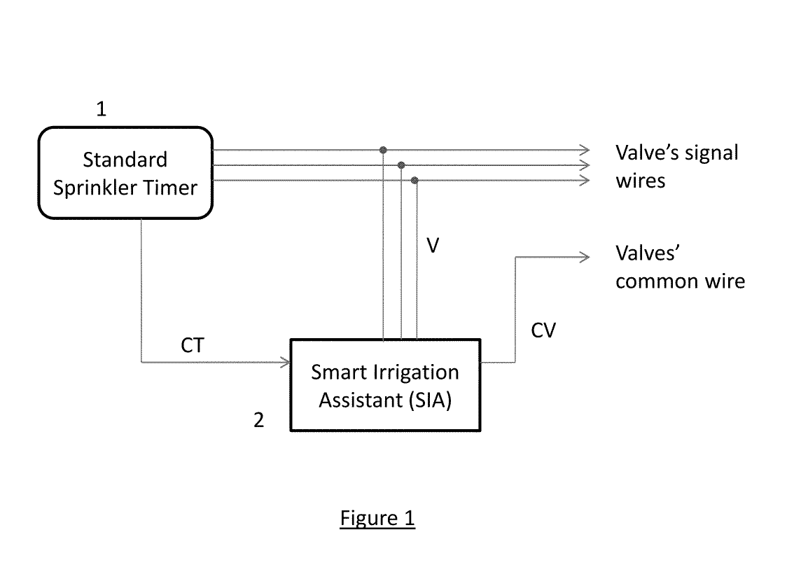

From FIG. 1, a standard sprinkler timer 1 has a 24 Volt Alternating Current (AC) signals connected to the valves wires, wherein The SIA's wires labeled V also connect to these signals in any order. For the common wire, the SIA has two common wires labeled CT and CV. The CT wire connects to the common wire of the standard sprinkler timer and the CV wire connects to the valves' common wire. The SIA is energized by the standard sprinkler timer and only during the scheduled watering times.

The SIA does not require a separate power supply thus it can be installed at the irrigation valves location.

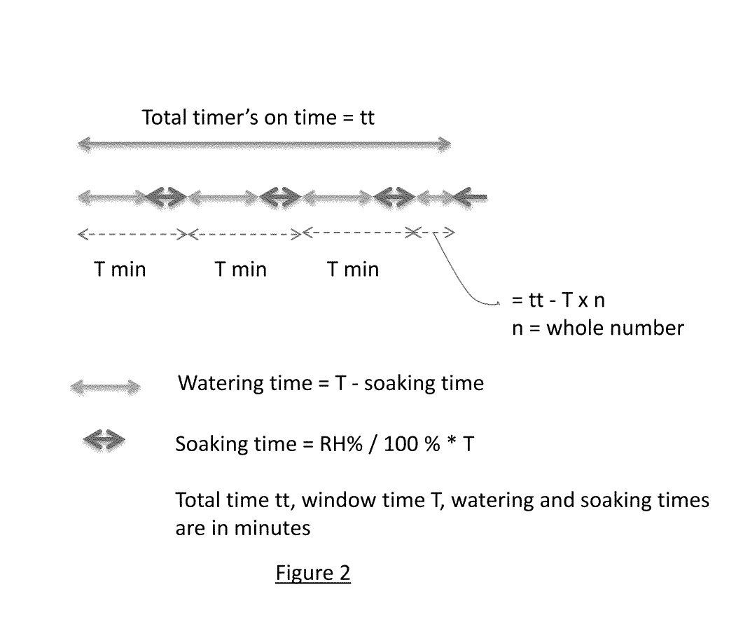

From FIG. 2, the total time tt programmed into the standard sprinkler timer is broken down into T minute cycles or windows by the SIA. In each window equals T minutes, the SIA turns the irrigation valves on for “T−soaking time” minutes. The soaking time is calculated as RH%/100%*T in order to allow the water to soak into the soil and prevent runoff. This is a unique watering approach which allows the SIA to optimize the ground absorption of water. The watering time and the soaking time are determined depend on the relative humidity.

### EXAMPLE

A, the area of irrigation zone, is 400 square feet,

RH, the relative humidity, is 40%,

T, the window time, is 10 minutes,

K, the variation factor, is 1 by default,

Using the equation: tt (minutes/week)=k×0.2×A (square feet)

Soaking time=RH%/(100%/T)

Watering time=T−Soaking time

The standard irrigation timer will be set to 80 minutes per week for this zone.

If the relative humidity is 40% the SIA will set the watering time to be 6 minutes during each 10 minute cycle. The remaining time, 4 minutes, in each 10 minute cycle allows the water which has been delivered to soak into the ground.

What is claimed is:

1) The Smart Irrigation Assistant (SIA) adaptor combined with the standard sprinkler timer automatically controls the amount of watering time according to the air Relative Humidity (RH) in the irrigated area. Instead of watering the total time set on the standard sprinkler timer, the SIA divides the total time into window(s) of equal time. Within each window, as the relative humidity increases, the watering time for the zone being controlled is shortened. The remainder of the time of the window is used to allow the water that has been delivered to soak into the ground. If the relative humidity exceeds 90%, the watering time is reduced to zero. The SIA is connected to each of the control valves attached to the standard sprinkler timer and in series with common return wire that connects to each valve. The SIA breaks the connection on the common circuit to the valves in order to stop the flow of water to the zone being controlled. The SIA is powered by the voltage supplied to the valves. The SIA comprises the followings:
A 24 Volt AC to 5 Volt DC power circuitry.
Circuitry generates a periodic waveform which the frequency is dependent upon the capacitance of the relative humidity sensor.
A processor to measure the pulse width or the frequency of the waveform and to determine the amount of watering time and soaking time based upon the derived relative humidity of the air.
A control module to turn on and off the irrigation valves for each zone.

2) The Smart Irrigation Assistant of claim 1, wherein converts the 24 Volt AC from the standard sprinkler timer into 5 Volt DC source to use for the control circuitry of the Smart Irrigation Assistant.

3) The Smart Irrigation Assistant of claim 1, wherein the processor generates a periodic signal with frequency varying with the capacitance of the relative humidity sensor. This capacitance is correlated to the air Relative Humidity.

4) The Smart Irrigation Assistant of claim 1, wherein the processor determines the pulse width or the frequency of the signal. The pulse width corresponds to the frequency of the signal.

5) The Smart Irrigation Assistant of claim 1, wherein the processor determines the watering time and soaking time for each window dependent upon the pulse width or frequency of the signal from claim 3.

6) The Smart Irrigation Assistant of claim 1, wherein the controller turns on and off the irrigation valves dependent upon the watering time and soaking time determined in claim 5.

7) The Smart Irrigation Assistant of claim 1, wherein the total watering time per zone can be calculate by the formula:
T(minutes/week)=k×0.2×A;
Where:
T is the total watering time per zone needed to be set on the standard irrigation timer in minutes per week.
k is a coefficient which is dependent upon fixed attributes of the irrigation zone. Default k=1.
A is the area of the irrigated zone in square feet.

8) The Smart Irrigation Assistant of claim 7, wherein the default watering time per zone is adjusted according to other factors such as: type of soil, type of grass or plants being watered, type of delivery system, (e.g., spray, rotary, drip etc.), type and size of delivery pipe, and water pressure. This is used to define the value of k in the equation listed in claim 7.

9) The Smart Irrigation Assistant of claim 1, wherein the window(s) of watering time and soaking time as described in claim 1 equal the addition of watering and soaking time. There might be one or several windows of watering and soaking repeating until the total time per zone calculated by the formula in claim 7 runs out. This unique method of watering has several advantages comparing to watering the total required watering time continuously.
a) Even though the total irrigation time of the sprinkler timer varies, the SIA can achieve the total irrigation time automatically without the requirement of adjustments. b) The SIA can adjust the watering and soaking time in each window automatically depending upon the relative humidity just before the irrigation session.
c) In case the total irrigation time is not a multiple of the window time, in the last window, the irrigation session might end during watering or soaking time. But because the watering time runs before the soaking time, there should not be under watering if the total running time of the standard sprinkler timer is adequate.

10) The Smart Irrigation Assistant of claim 9, wherein the window(s) of watering and soaking time described in claim 1 can be calculated by the below formula. Depend on unique conditions for each irrigated area, different formulas might be used.
For window(s)=T minutes, Relative Humidity=RH%,
Soaking time=RH%/100%*T minutes
Watering time=T−Soaking time.
Example:
For window T=10 minutes, RH%=40%
Soaking time=40%/100%*10 minutes=4 minutes for each window
Watering time=10−4=6 minutes for each window.
